(19) United States
(12) Patent Application Publication
(10) Pub. No.: US 2007/0021978 A1
(43) Pub. Date: Jan. 25, 2007

(54) System and method for clinical cost capture on a job cost basis

(75) Inventors: John H. Gragg, Overland Park, KS (US); Brian J. Lancaster, Merriam, KS (US); Kent D. Parkins, Parkville, MO (US); Michael E. Yarbrough, Lees Summitt, MO (US)

Correspondence Address: SHOOK, HARDY & BACON L.L.P.;Intellectual Property Department, 2555 GRAND BOULEVARD, KANSAS CITY, MO, 64108-2613, US

(73) Assignee: Cerner Innovation, Inc., Overland Park, KS (US)

(21) Appl. No.: 11/325,019

(22) Filed: Jan. 3, 2006

Related U.S. Application Data
(60) Provisional application No. 60/714,540, filed on Jan. 3, 2005.

(51) Int. Cl. G06Q 10/00; G06F 7/00; G06F 17/00

(52) U.S. Cl. 705/2; 707/101; 705/400

(57) ABSTRACT

A method and system for generating job costing data are provided. The method may include performing job costing in a healthcare environment by automatically retrieving information including a group of descriptive attributes from a data store. The group of descriptive attributes may form a patient encounter and the descriptive attributes may represent content electronically captured during patient care. The method may additionally include associating cost data from the data store with each descriptive attribute representative of the patient encounter retrieved from the data store and combining the descriptive attribute costs for the group of descriptive attributes to determine a patient encounter cost.

### CROSS-REFERENCE TO RELATED APPLICATIONS

This application claims the benefit of U.S. Provisional Application No. 60/______, filed Jan. 3, 2005 (attorney docket no. CRNI.117426) (originally filed as a nonprovisional application and granted U.S. application Ser. No. 11/025,994; Petition to Convert Nonprovisional Application to Provisional Application under 37 C.F.R. § 1.53(c)(2) filed Oct. 4, 2005), which is hereby incorporated by reference as if set forth in its entirety herein.

### STATEMENT REGARDING FEDERALLY SPONSORED RESEARCH OR DEVELOPMENT

None.

### TECHNICAL FIELD

Embodiments of the present invention relate to techniques for capturing clinical data and determining costs in a clinical setting. More particularly, embodiments of the invention are directed to a job costing technique in a healthcare environment.

### BACKGROUND OF THE INVENTION

Cost accounting is the general practice of taking costs or expenses that are recorded on a general ledger system and allocating the costs and expenses to volumes of provided goods and services. In a general ledger system, costs and expenses are recorded by the department or area in which they are incurred. Since products and services provided are typically supported by multiple departments or areas, the costs recorded on the general ledger for any particular department will therefore only represent a portion of the total costs for any particular product or service. This phenomenon is particularly true in healthcare, as a patient will likely receive services from many different departments during the patient's treatment. The cost accounting technique presumes that charges can be used as an estimate of resources utilized in providing any particular service.

In its first generation form, cost accounting in healthcare was introduced through its use as a government reimbursement methodology for Medicare. Given the government's commitment to reimburse healthcare providers based on their costs, a system was required to calculate the costs associated with the provision of services to Medicare patients. A technique developed that allocated costs based on the portion of total charges for a particular department that were produced by Medicare patients. The higher that Medicare charges were as a percentage of total charges for a particular department, the higher the costs that would be allocated to Medicare patients, and hence reimbursed by the government. Over time, hospitals learned that by increasing the charge amounts for procedures that had a heavy utilization by Medicare patients, their reimbursement by the government could be increased. This process was known as cost-shifting, and became prevalent throughout the industry, thereby artificially inflating charges for services that were utilized heavily by Medicare patients, resulting in inaccurate cost estimates.

Further cost accounting techniques arose as a response to payment methodologies later introduced by the government. The government changed reimbursement formulas from cost-based to a preset amount based on the diagnosis of the patient. Thus, cost accounting methodologies developed that focused on breaking down the provision of patient care into procedures. The procedure costs could subsequently be combined into the total costs for every patient based on the procedures used for each particular case or stay. Many facilities initially developed a “bill of materials” for each chargeable procedure, which equated to a direct cost that could be identified based on the labor, supplies, and other materials used in that procedure. The method then calculated the difference between the summation of these individual costs and the costs reported on the general ledger, and allocated this difference using the direct costs as an allocation basis. This allocation procedure, generally called “Standards Development”, was derived from the management accounting practices used in the manufacturing industry.

Due to the dynamic nature of how patients are treated in the healthcare setting. Based on individual physician preferences, changes in technology, and differences between costs of supplies and pharmaceuticals between various vendors, the list of resources used in the provision of services for any particular procedure could change monthly and even weekly. Most facilities that did not have a dedicated staff of management engineers ended up abandoning this methodology.

Subsequently, an approach called Relative Value Units (RVUs), evolved for allocation of general ledger costs to the individual procedures performed in a facility. Instead of building a bill of materials for each procedure, this approach uses a single statistic, or RVU, as the basis for allocation of general ledger costs to a chosen volume indicator. As long as the “relative” relationship between each charge item was correct for a particular department, the end result of the allocation of general ledger costs was very close to the total costs that were calculated using the earlier standards development approach. However with this approach, the costs represented the average cost and not the actual cost of providing any particular service.

Another accounting technique used in some industries is a job order costing technique. The job order costing technique identifies the cost of each component involved in a job. The costs of materials, labor, and other resources used to complete a job are summed to determine the actual cost of the job.

In the healthcare industry, job order costing has not been a viable technique for several reasons. First, it has been impossible to capture each and every component involved in a patient encounter. Secondly, it has not been possible to determine the cost of each of the components involved in the encounter. Furthermore, various laws, rules, and regulations prevent charging different patients different amounts for the same type of procedure. For example, an obese patient having an operation might require an extra nurse for transporting the patient. The obese patient may also require a larger bed. Despite the fact that this patient may cost more than the average patient having the same operation, regulations may require that every patient be charged the same amount for the same overall procedure.

Overall, healthcare institutions would benefit from using a direct approach to determine job costs for each patient encounter. Even if healthcare institutions are unable to charge each patient based on his or her action costs, if healthcare institutions are aware of the cost of each encounter, the institutions can more accurately describe to payers the costs involved with caring for the patients for whom the payers are responsible. Accordingly, a solution is needed that includes all of the pre-requisites for implementing a job order costing approach in a healthcare environment.

### BRIEF SUMMARY OF THE INVENTION

In accordance with an embodiment of the invention, a method is provided performing job costing in a healthcare environment. The method includes automatically retrieving information including a group of descriptive attributes from a data store. The group of descriptive attributes forms a patient encounter and each descriptive attribute represents content electronically captured during patient care. The method further includes associating cost data from the data store with each retrieved descriptive attribute representative of the patient encounter. The method additionally includes combining the descriptive attribute costs for the group of descriptive attributes to determine a patient encounter cost.

In an additional embodiment, a system is provided for generating job costing information in a healthcare environment including automated information capture equipment. The system may include a data storage area for storing clinical data including descriptive attributes and attribute cost data. The system may additionally include a retrieval component for retrieving a group of descriptive attributes from the data storage area. The descriptive attributes may be captured by the automated information capture equipment and the retrieved descriptive attribute group may form a patient encounter. The system may also include an association component for associating each retrieved descriptive attribute with a cost stored as attribute cost data and an implementation component including a mechanism for generating job costing information indicating a patient encounter cost based on created associations.

### BRIEF DESCRIPTION OF THE DRAWINGS

The present invention is described in detail below with reference to the attached drawings figures, wherein:

FIG. 1 is a block diagram illustrating components of a job costing environment in accordance with an embodiment of the invention;

FIG. 2 is a block diagram illustrating components of a job costing system in accordance with an embodiment of the invention;

FIG. 3 is a block diagram illustrating components of a central database in accordance with an embodiment of the invention; and

FIG. 4 is a block diagram illustrating a method for job costing in accordance with an embodiment of the invention.

### DETAILED DESCRIPTION OF THE INVENTION

Embodiments of the present invention are directed to a system and method for job order costing in a healthcare environment in an accurate and automated manner. The approach described herein includes identifying each descriptive attribute involved in a patient encounter and combining costs for each descriptive attribute involved in the patient encounter. The method and system for job costing using descriptive attributes add an increased level of granularity to contribute to the improved accuracy of job costing results.

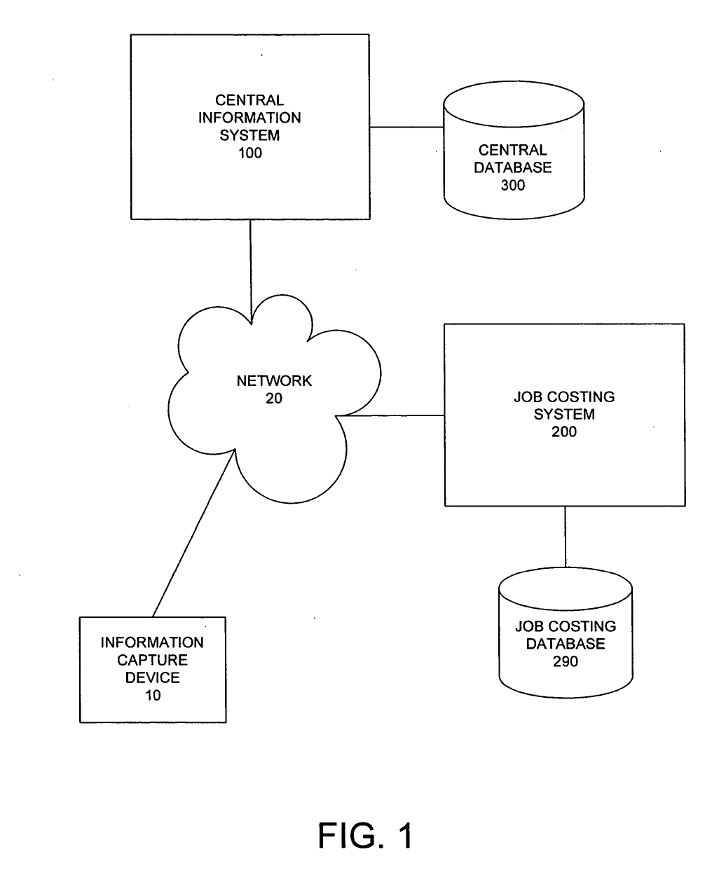

The following discussion describes embodiments of the invention with reference to FIGS. 1-4. FIG. 1 illustrates an environment in which job costing may be managed. An information capture device 10 may be connected over a network 20 with a central information system 100. The central information system 100 may be connected with a central database 300. A job costing system 200 may also be connected over the network 20 and may optionally access a job costing database 290. Alternatively, the job costing database 290 may be excluded and all relevant information may be stored in the central database 300.

The information capture device 10 may capture content of a fine level of granularity and each piece of captured content can be defined as a clinical or descriptive attribute. In a clinical setting, a patient may be viewed as the broadest category. To reach lower levels of granularity, an encounter with a patient is considered. The encounter leads to a physician procedure or order, followed by resultant events and activities. These events and activities are captured by the information capture device 10.

The information capture device 10 may be or include a caregiver portable computing device that enables a caregiver to record each event that occurs with respect to a patient. The information capture device 10 may be a personal computer, and typically includes many of the elements described below relative to the central information system 100. In embodiments of the invention, the information capture device 10 may include a memory, processing unit, battery, user interface tools, a network interface, RF communication tools, and identifier recognition tools. The identifier recognition tools may include a scanning device or other reading mechanism for reading machine-readable identifiers. The information capture device 10 may read machine-readable identifiers associated with a patient, a medication, or a piece of equipment to record the use of a medication or equipment and the treatment of a patient. After capture, the information capture device 10 may send the information over the network 20 to the central information system 100.

In order to implement the information capture device 10, each patient may be identified by a patient identification device and each medical device and medication may be identified by a medical device or medication identification device. A caregiver identification device may identify a caregiver. Upon transfer of identity information to the central information system 100, each caregiver, patient, and each medication and medical device can be verified with the central information system 100.

Furthermore, the information capture device 10 may include one or more devices that have the capability to capture such information as labor times in pathology tests, actual pharmaceutical costs and dispensing modes, supply chain acquisition costs, and radiology exam times. As will be explained below, this captured information is usable in job costing.

The central information system 100 preferably includes known computing components such as a memory, a processing unit, and interfaces for allowing communication with a user, a network, and peripheral devices. A system bus may couple the aforementioned components. Upon receiving captured information, the central information system 100 may store the information in the central database 300.

The memory of the central information system 100 may include computer storage media in the form of volatile and/or nonvolatile memory such as read only memory (ROM) and random access memory (RAM). A basic input/output system (BIOS), containing the basic routines that help to transfer information between elements within the central information system 100, such as during start-up, is typically stored in the ROM. The RAM typically contains data and/or program modules that are immediately accessible to and/or presently being operated on by processing unit. The central information system 100 may also include other removable/non-removable, volatile/nonvolatile computer storage media. A hard disk drive may be provided that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM or other optical media. Other removable/non-removable, volatile/nonvolatile computer storage media may be used.

By way of example, and not limitation, the central information system 100 may include an operating system, application programs, other program modules, and program data. The application programs and other programs may be described in the general context of computer-executable instructions, such as program modules, being executed by a computer. Generally, program modules include routines, programs, objects, components, data structures, etc. that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like.

A user may enter commands and information into the central information system 100 through a user interface using input devices such as a keyboard and pointing device, commonly referred to as a mouse, trackball or touch pad. Other input devices may also be used and may be connected to the processing unit through a user input interface that is coupled to a system bus or other structure.

The central information system 100 may operate in a networked environment in conjunction with the network 20 as illustrated in FIG. 1, using logical connections to one or more remote computers, such as the information capture device 10. The network 20 may be the Internet and all components of the system may be accessible over the Internet. Logical connections for networking may include a local area network (LAN) or a wide area network (WAN), but may also include other networks. When used in a LAN networking environment, the central information system 100 may be connected to the LAN through a network interface or adapter. When used in a WAN networking environment, the central information system 100 typically includes a modem or other means for establishing communications, such as the Internet.

FIG. 3 illustrates the central database 300 in accordance with embodiments of the invention. The central database 300 may include clinical data 310, supply and resource data 320, payer data 330 and attribute cost data 340. The clinical data 310 will typically include data captured by the information capture device 10 and/or data manually entered by a caregiver through the information capture device 10 or the central information system 100. The clinical data 310 may include patient records 312, device records 314, caregiver records 316, and outcomes data 318. The patient records 312 may include a treatment history or an electronic health record (EHR) for each patient including orders entered by a physician for treatment of each patient. The device records 314 may include information device settings and capabilities as well as each discrete usage of each device recorded by the information capture device 10. The caregiver records 316 may also include records of assigned tasks for each caregiver in the system and each task performed by a caregiver as recorded by the information capture device 10. The caregiver records 316 may additionally include salary and wage data pertaining to each caregiver. The outcomes data 318 may include records of patient mortality, infection, or other outcomes of medical treatment. The outcomes data 318 may be manually entered by a caregiver through the information capture device 10 or directly into the central information system 100.

As shown in FIG. 3, the central database 300 also includes attribute cost data 340. The attribute cost data 340 may include a list of treatment activities and a cost associated with each of these activities. These costs can in part be determined from cost and resource data 320. Cost and resource data 320 may include periodically updated information related to the costs of medications, other medical supplies, and labor. Thus, each item on the list of treatment activities may have a periodically updated associated cost. For example, one item on the list of treatment activities may include a nurse administering a specified quantity of a drug. Both the quantity of the drug and the nurse's labor time have an associated cost, which may be periodically updated based on the supply and resource data 320. As a further example, another item on the list of treatment activities may include a nurse transporting a patient from room A to room B. Both the nurse labor time and the cost of equipment use for the transport time may be costs for this activity.

Thus, the descriptive attribute cost data 340 provide a comprehensive menu of attributes along with associated costs for each attribute. This descriptive attribute cost menu minimizes the effects of averaging. For example, each nurse on a floor may make a slightly different salary. Instead of averaging nurse costs, the job costing system 200 allows identification of a particular nurse in association with a descriptive attribute. Accordingly, direct costing is implemented rather than averaging of wage rates. These costs should be maintained within the attribute cost data 340.

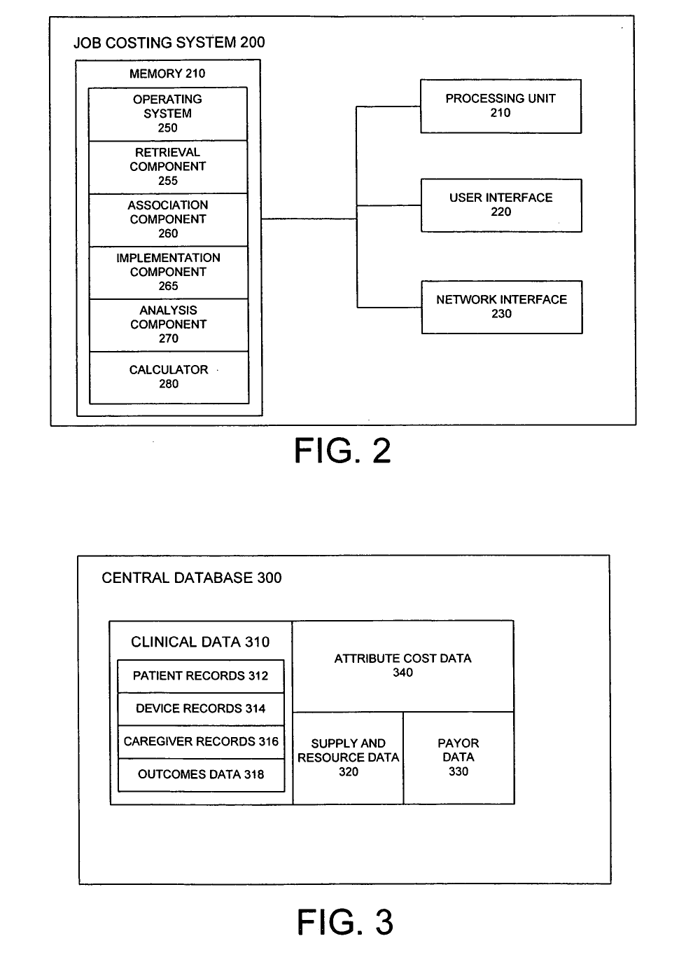

FIG. 2 illustrates further details of the job costing system 200 in accordance with an embodiment of the invention. The job costing system 200 may include a processing unit 210, a user interface 220 and a network interface 230. The job costing system 200 may additionally include a memory 240. The job costing system 200 may also include computing components such as those described above with reference to the central information system 100. The memory 240 may include an operating system 250, a retrieval component 255, an association component 260, an implementation component 265, an analysis component 270, and a calculator 280. Optionally, the job costing system 200 may be connected with a job costing database 290. Alternatively, all data relevant to the job costing system 200, such as the attribute cost data 340 and supply and resource data 320, may be stored in the central information system database 300.

The retrieval component 255 may upon request, operate to retrieve information pertaining to clinical events, costs, supplies, etc. for the central information database 300. The association component 260 may determine the cost of each retrieved clinical attribute based on stored attribute cost data 340. The implementation component 265 may combine the clinical attribute costs in order to determine a patient encounter cost. Thus, the implementation component 265 may include cost algorithms for calculating costs at a selected level of granularity that is broader than the level of content captured and retrieved by the retrieval component 255.

The calculator 280 may be employed on a periodic basis to update clinical attribute cost data 340 based on the updated supply and resource data 320. Thus, the calculator 280 may include algorithms for assigning costs to descriptive attributes or captured content. The calculator 280 may extract information from stored device records 314, caregiver records 316, and supply and resource data 320 to derive the attribute cost data 340.

The implementation component 265 may include cost algorithms to further roll up costs by population. For instance, the implementation component 265 may roll up costs by product lines, services, physician, payer, or programs. Furthermore, the implementation component 265 can produce summarized cost information along virtually any dimension of the patient population. The implementation component 265 may produce cost analyses by physician, surgeon, procedure, and case. The implementation component 265 may also be configured to produce cost analyses by service line, diagnoses, program, department, financial class, payer, insurance plan, and contract. The implementation component 265 may assign costs directly to individual patient record by leveraging automated capture and the central information system database 300.

The analysis component 270 may be used in conjunction with the implementation component 265 for a number of analyses. For example, the analysis component 270 may utilize outcomes data 318 in combination with attribute cost data 340 to determine a relationship between costs and outcomes. For example, a rate of infection may be correlated with a low cost descriptive attribute and the rate may be significantly diminished through the use of a slightly higher cost descriptive attribute. In an alternative scenario, the performance of a higher cost activity may not serve to avoid detrimental outcomes. The analysis component 270 may make this determination. Based on this determination, the healthcare administrators may decide whether or not selected activities should be performed in every related patient encounter or in any patient encounter.

Furthermore, the analysis component 270 can analyze payer data 330 in relation to patient encounter costs determined by the implementation component 265. The analysis component 270 can determine which patients are associated with a particular payer and from that information, determine whether the payer is contributing sufficiently to the payer's share of patient encounter costs.

The job costing system 200 may reside on a server platform, such as for example, a dedicated MS Windows or UNIX server platform running for example either SQL server 2000 or Oracle. Additional servers may also be included to support scalability and redundancy.

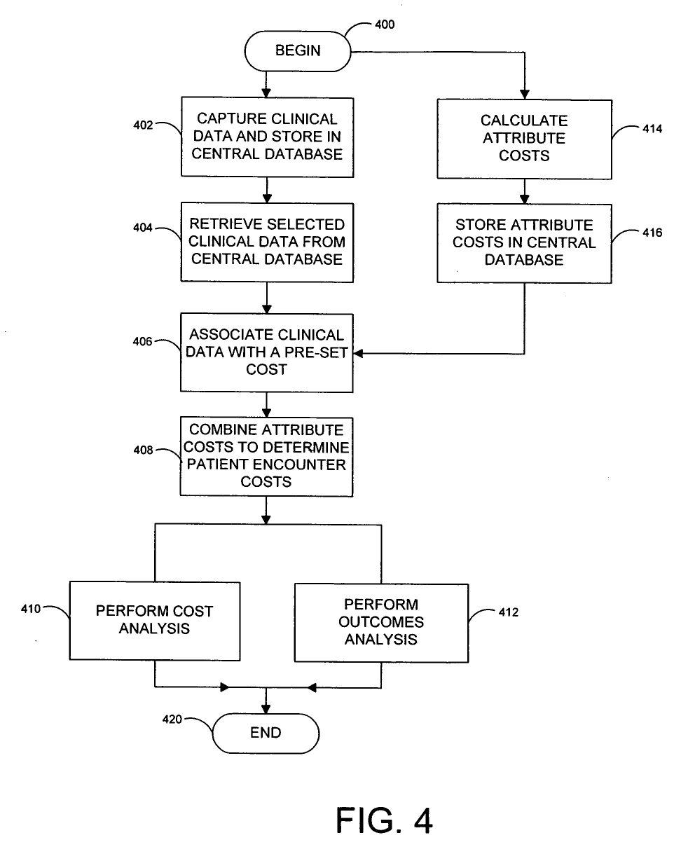

To illustrate the operation of the aforementioned components, FIG. 4 illustrates a job costing method in accordance with embodiments of the invention. The method begins in step 400. In step 402, the information capture device 10 captures clinical data and sends the clinical data for storage in the central database 300. In step 404, the retrieval component retrieves clinical data from the central database 404. In step 406, the job costing system 200 associates clinical data with a pre-set cost. The job costing system 200 may continuously and simultaneously determine these pre-set costs in steps 414 and step 416. As shown in FIG. 4, the calculator 280 may calculate attribute costs in step 414 and the job costing system 200 may store the costs in the central database 300 in step 416 as attribute cost data 340.

The automated capture step 402 may be performed with the information capture device 10 as described above. As set forth above, the information capture device 10 preferably includes a scanner or other mechanism for reading identifiers such as barcodes or RFIDs associated with a caregiver, a patient, a medication, or a piece of equipment. The information capture device 10 may capture each dispensation of medication, each use of equipment, and each procedure performed on a patient or performed by a caregiver. By using the clinical information 310 including the EHR, each clinical attribute pertaining to a patient's stay is captured in the system. This includes, but is not limited to results, timing of an activity, resource time spent on an activity, medication administration timing etc. As these clinical attributes are captured as clinical documentation and stored in the EHR, key clinical attributes are selected by the cost accountants or the job costing system 200. The job costing system 200 automatically assigns the appropriate cost allocations, making the job costing process seamless to the care processes, creating a maintained and updated job costing system 200.

For example, as a nurse uses the EHR to perform a follow-up assessment, to administer an antibiotic or to confirm that lab work is complete, the information capture device 10 records the activity that drives the job costing process and stores it in the EHR, creating a well-maintained and accurate cost allocation methodology.

In step 404, the job costing system 200 may retrieve the information, or content that includes attributes, directly from the information capture device 10 using the retrieval component 255 or from the central database 300 after the information capture device 10 has transferred the information to the central information system 100.

In step 406, the job costing system 200 implements the association component 260 to perform an association process. By allocating costs to items of finer granularity that form the procedure or an overall patient encounter, healthcare administrators, through the job costing system 200, can more clearly understand the costs being used for that procedure and ultimately have better control over these costs. For instance, the association component 260 may receive all descriptive attribute costs or receive the information to determine descriptive attribute costs. Many pieces of captured content can be associated with a selected patient and combined to allocate all costs for all content associated with the patient encounter. Ultimately, the job costing system 260 may develop costs at the charge level, the activity level, the clinical encounter level, or at other selected levels. Regardless of which level is selected, the association component 270 may begin with a fine level of granularity characterized by the descriptive attribute. After determining the appropriate volume indicator, the system proceeds to step 408 for implementation.

In step 408, the job costing system 200 uses the implementation component 265 to perform an implementation process. The implementation component 265 may include costing algorithms configured to combine descriptive attribute costs in order to arrive at a patient encounter cost in step 408. The implementation component 265 may further include tools for combining costs for an organizational unit or department, by product lines, services, physician, payer, or programs. Furthermore, the implementation component 265 can produce summarized cost information along virtually any dimension of the patient population. The implementation component 265 may also be configured to produce cost analyses by such features as diagnoses, program, financial class, payer, insurance plan, and contract.

Steps 410 and 412 may be performed continuously or at any time desired by healthcare administrators. By considering the costs determined by the implementation component along with stored data such as payer data 330, the analysis component 270 can determine if a payer is sufficiently funding its patient encounters. The analysis component 270 is capable of delivering useful analyses to healthcare managers. These analyses may be used in the contract negotiation process with payers. If a selected payer's clients are costing the healthcare institution in excess of average amounts, this fact will be documented by the job costing system and may enable healthcare institutions to negotiate for more funds from these payers. The analysis component 270 may further enable the healthcare managers to identify inefficiencies. For example, patients undergoing a specified procedure may be transferred a distance that results in greater expense. As a result, managers could determine a more efficient transfer pattern by moving departments or other techniques.

In step 412, the analysis component 270 may compare outcomes data 318 with costs in order to provide data relevant to possible modification of standard procedures. For instance, if a high cost procedure is typically performed, but does not enhance outcomes, healthcare administrators may decide to omit the high cost procedure from standard patient encounters. By storing detailed cost data in the same central database location as clinical data, healthcare managers can determine for example, for the total knee patients following this specified pathway, what were the costs, what were the mortality rates, infection rates, etc. Using the disclosed job costing technique, decision makers may look at the cost of a certain treatment and determine if a higher cost treatment is justifiable.

The granular level of a descriptive attribute used in the job costing process may be further explained in relation to the procedure of a chest x-ray. Multiple clinical or descriptive attributes make up this procedure. For the postero-anterior view, the radiology technician typically positions the shield, prepares the patient, provides instructions, activates the radiographic equipment, and removes the exposed film and replaces it with new, unexposed film. The technician repeats all of these steps for a lateral view. Each step in the process is an attribute. Any of these detailed steps could have a larger impact to the total cost of the procedure.

Job costing builds up costs from a detailed level instead of starting at the cost level general ledger. Combining of costs using the lowest common denominator, the clinical or descriptive attribute, and supports the ability to analyze the costliness of detailed activities that would not be supported by procedure level allocations. For instance, the disclosed system may support incorporating the cost of registered nurse time to take vital signs or the cost for each hour a patient is on a ventilator. By analyzing clinical details, the job costing system 200 can reveal detailed costs instead of average procedure costs applied to a broader procedure definition.

An additional example is illustrated with reference to a total knee procedure. Using an embodiment of the invention, costs for the procedure may accurately be determined and documented by descriptive attribute. Total knee procedure steps can be grouped into the classifications of pre-operative and circulating, each of which has detailed steps. For example, the pre-operative steps would include reviewing the surgery plan, performing a follow-up assessment, administering antibiotics, confirming that lab work is complete, confirming the arrival of implants and supplies, and shaving the patient. The circulating steps could include documenting intra-operative events, assisting the surgical team, monitoring and assessing the patient, obtaining add-on items as needed, administering and documenting blood information, communicating a report to a recovery area, and transporting the patient to the recovery area. The clinical details give the healthcare manager, through the job costing system 200, insight into which detailed step (or attribute) is having the largest impact to the overall costliness of the procedure, ultimately improving the accuracy of the cost accounting results.

The process of using descriptive attributes to perform job costing provides benefits to the users of this process that have been absent in traditional cost accounting processes in healthcare. One benefit includes automated association and accumulation of volumes, which provides simplified methodology for maintaining and generating results. Another benefit includes improved accuracy of the job costing results through use of increased granularity.

While particular embodiments of the invention have been illustrated and described in detail herein, it should be understood that various changes and modifications might be made to the invention without departing from the scope and intent of the invention. The embodiments described herein are intended in all respects to be illustrative rather than restrictive. Alternate embodiments will become apparent to those skilled in the art to which the present invention pertains without departing from its scope.

From the foregoing it will be seen that this invention is one well adapted to attain all the ends and objects set for above, together with other advantages, which are obvious and inherent to the system and method. It will be understood that certain features and sub-combinations are of utility and may be employed without reference to other features and sub-combinations. This is contemplated and within the scope of the appended claims.

What is claimed is:

1. A method for performing job costing in a healthcare environment, the method comprising:
automatically retrieving information including a group of descriptive attributes from a data store, the group of descriptive attributes forming a patient encounter, wherein the descriptive attributes represent content electronically captured during patient care;
associating cost data from the data store with each descriptive attribute representative of the patient encounter retrieved from the data store; and
combining the descriptive attribute costs for the group of descriptive attributes to determine a patient encounter cost.

2. The method of claim 1, wherein retrieving information comprises retrieving information from an electronic health record.

3. The method of claim 1, wherein retrieving information comprises retrieving information pertaining to caregiver labor time.

4. The method of claim 1, wherein retrieving information comprises retrieving a record of medical device usage.

5. The method of claim 1, further comprising storing clinical data and attribute cost data in a single database.

6. The method of claim 5, wherein retrieving information comprises retrieving descriptive attributes from the single database.

7. The method of claim 1, further comprising summarizing cost information along a patient dimension including one of treating physician, department, diagnosis, procedure, and insurance plan.

8. The method of claim 1, further comprising storing captured outcomes in the data store.

9. The method of claim 8, further comprising analyzing descriptive attribute cost data from the data store with relation to captured outcomes in the data store.

10. The method of claim 1, further comprising storing payer information in the data store and analyzing patient encounter costs for each payer.

11. A computer-readable medium storing computer-readable instructions for performing the steps recited in claim 1.

12. A system for generating job costing information in a healthcare environment including automated information capture equipment, the system comprising:
a data storage area for storing clinical data including descriptive attributes and attribute cost data;
a retrieval component for retrieving a group of descriptive attributes from the data storage area, the descriptive attributes captured by the automated information capture equipment, the retrieved descriptive attribute group forming a patient encounter;
an association component for associating each retrieved descriptive attribute with a cost stored as attribute cost data; and
an implementation component including a mechanism for generating job costing information indicating a patient encounter cost based on created associations.

13. The system of claim 12, wherein the data storage area additionally stores payer data.

14. The system of claim 13, further comprising an analysis component for analyzing payer data with respect to patient encounter cost for each patient funded by the payer.

15. The system of claim 12, wherein the data storage area further comprises outcomes data.

16. The system of claim 15, further comprising an analysis component for analyzing outcomes data in relation to descriptive attribute costs.

17. The system of claim 12, wherein the descriptive attributes are stored as clinical data.

18. The system of claim 17, wherein the clinical data comprises patient records, device records, and caregiver records captured by the automated capture device.

19. The system of claim 17, wherein the clinical data comprises electronic health records.

20. The system of claim 12, wherein the data storage area additional includes supply and resource data.

21. The system of claim 12, wherein the retrieval component retrieves captured data from the data storage area.

22. The system of claim 12, wherein the implementation component comprises cost algorithms for summarizing costs by population.

23. The system of claim 12, wherein the implementation component comprises cost algorithms for producing an analysis by one of physician, surgeon, procedure, case, and insurance plan.
